(19) United States
(12) Patent Application Publication
(10) Pub. No.: US 2003/0102809 A1
(43) Pub. Date: Jun. 5, 2003

(54) Laser guided display with persistence

(76) Inventor: Raja Tuli, Montreal (CA)

Correspondence Address: RAJA TULI, SUITE 1130, 555 RENE LEVESQUE WEST, MONTREAL, QC, H2Z1B1, CA

(21) Appl. No.: 10/341,379

(22) Filed: Jan. 14, 2003

Related U.S. Application Data
(63) Continuation-in-part of application No. 09/918,523, filed on Aug. 1, 2001.

(51) Int. Cl. G09G 1/28

(52) U.S. Cl. 315/11.5; 315/9

(57) ABSTRACT

The present invention aims to provide a display device comprised of a matrix array of pixels on a monolithic screen, each pixel addressed by an infrared scanning laser. The screen is primarily a phototransistor circuit, which produces a light output at each pixel on which the laser scans. As the laser strikes a photosensitive region on the display, hole and electron pairs are created and they persist to provide light output of a slowly degrading intensity. Reverse polarizing the transistor circuit terminates light output. Modulating the laser's duration and or intensity provides a proportional intensity output at each pixel. The display screen is designed to be removable from its location within a housing.

“This application is a continuation in part of application Ser. No. 09/918,523 filed on Aug. 1, 2001.

### BACKGROUND OF THE INVENTION

1. Field of the Invention

The invention relates to a laser beam, which scans a display screen comprised of a pixel array of photocells or phototransistors each in the presence of an electric field. The laser's intensity and duration on each photocell produces a desired light output for that pixel. Implementing a color phosphor panel against the photo emitter area, or patterned colors on the photo emitter, would produce a color display.

2. Prior Art

Prior Art of the invention would involve projection type displays vastly different from the present invention, as-these do not utilize a scanning laser to energize pixels on the display screen. Other prior art would include active displays, which again do not utilize a scanning laser to energize pixels on the display screen.

### SUMMARY OF THE INVENTION

The present invention relates to providing a large screen display system utilizing a scanning laser. The laser scans the entire screen, which is comprised of a matrix array of picture elements or pixels. The display screen is of a monolithic composition comprising a traditional phototransistor construction. As the scanning laser beam strikes one region or pixel, light is emitted at that pixel. The incident light provided by the laser is infrared and the emitted light on the screen is blue, whereby the emitted light is of a higher intensity than the incident light as there is amplification present in the transistor circuit.

There is an electric field present across the phototransistor or display screen, which biases the transistor, thus providing a voltage across the transistor circuit. This complete transistor circuit allows a charge to flow. Basically, the infrared light from the laser strikes a photosensitive region or layer in the display screen that is sensitive to the infrared light, thereby reducing a barrier for carriers to flow through causing recombination in another area of the phototransistor circuit, resulting in light being emitted. The incident infrared laser light that strikes a photosensitive region of the display reduces a barrier for charged carriers to travel and recombine in another area of the phototransistor circuit, in the presence of an applied electric field, causing light to be emitted.

When the infrared laser beam strikes the photosensitive region, holes and electron pairs (or carriers) are created, and when those holes and electron pairs are created, they cause a current to flow causing light emission to occur, but there is a mechanism that makes the current persist for a longer period of time. In particular, the effect of those holes and electron pairs is that they reduce the barrier but they persist for a period of time, so that basically, the light output comes on very quickly as holes and electron pairs are created, but the light output is very slow in degradation. Persistence is due to the fact that once the barrier is reduced, it takes a certain amount of time to come back up. The resulting effect of the infrared laser beam striking the photosensitive region is that barrier is reduced for a large period of time, which is equal to or may be larger than the frame period.

The amount of persistence provided may be designed to be much longer than the picture or display frame period, and the voltage is turned off at the end of the frame period. This effectively terminates all light output instantaneously for all pixels on the display screen, for each frame period. However, the voltage applied to the transistor circuit may be reverse polarized at the end of each frame period, to get rid of all the charged carriers that are persisting there, thereby terminating all light output instantaneously for all pixels on the display screen, for each frame period. Alternately, the voltage applied to the transistor circuit may be cycled at the end of each frame period into a forward, reverse, forward, reverse polarization to get rid of all the charged carriers that are persisting there, thereby terminating all light output instantaneously for all pixels on the display screen, for each frame period.

Placing a phosphor coated panel comprising a matrix array of red, green, and blue pixels against the photo emitter, would result in light hitting the color phosphor pixels, which is reemitted in the various colors. Alternately, the emitted light can be directed through color filters against the photo emitter, to produce a color display. Furthermore, red, green, and blue colors may be patterned on the display screen to provide a color display.

Various methods may be employed to produce a gray scale display. The amount of time or duration the laser is focused on each pixel may be varied to produce a different output intensity for that pixel, which is proportional to the duration. The intensity of the laser may be varied on each pixel to produce a different output intensity for that pixel, which is proportional to the intensity. For display screens with very short persistence, the laser may scan various pixels many times of various amounts to produce a different output intensity for these pixels, thereby producing a gray scale display.

Multiple display screens may be arranged in a large matrix array to be scanned by the same laser or multiple lasers, thereby producing a very large display screen. Each display screen may be easily removed and replaced from the main housing by design.

An infrared projector may be used to scan all pixels simultaneously on the display screen instead of the scanning laser.

### BRIEF DESCRIPTION OF THE DRAWINGS

The invention is described in more detail below with respect to an illustrative embodiment shown in the accompanying drawings in which:

FIG. 1 illustrates the basic concept of the scanning laser against a display screen, in accordance with the present invention.

FIG. 2 illustrates a detailed construction of the display screen, in accordance with the present invention.

FIG. 3 illustrates the on-off cycles of the laser for each frame displayed, in accordance with the present invention.

FIG. 4 illustrates the lag in time between the first and last pixel scanned by the laser in a forward cycle on the display screen, in accordance with the present invention.

FIG. 5 illustrates the scanning sequence of the laser in a reverse cycle, in accordance with the present invention.

FIG. 6 illustrates multiple display screens scanned in sequence to produce a very large display screen, in accordance with the present invention.

FIG. 7 illustrates a phosphor-coated panel applied against the display screen to provide a color display, in accordance with the present invention.

FIG. 8 illustrates the difference in dot size as the angle of incidence changes, in accordance with the present invention.

FIG. 9 illustrates a grid placed between the laser and the display screen to provide an equal laser beam footprint on each pixel of the screen, in accordance with the present invention.

FIG. 10 illustrates a removable display screen, in accordance with the present invention.

FIG. 11 illustrates the effect of light feedback causing persistence, in accordance with the present invention.

FIG. 12 illustrates a panel of color filters against the photo emitter used to produce a color display, in accordance with the present invention.

FIG. 13 illustrates an infrared projector used to scan each pixel on the display screen simultaneously. The display screen is also shown to have colors patterned on it to produce a color display, in accordance with the present invention.

FIG. 14 illustrates the lag in on time for the first and last pixel on the display screen for two consecutive frames, in accordance with the present invention.

### DETAILED DESCRIPTION OF THE PREFERRED EMBODIMENTS

To facilitate description, any numeral identifying an element in one figure will represent the same element in any other figure.

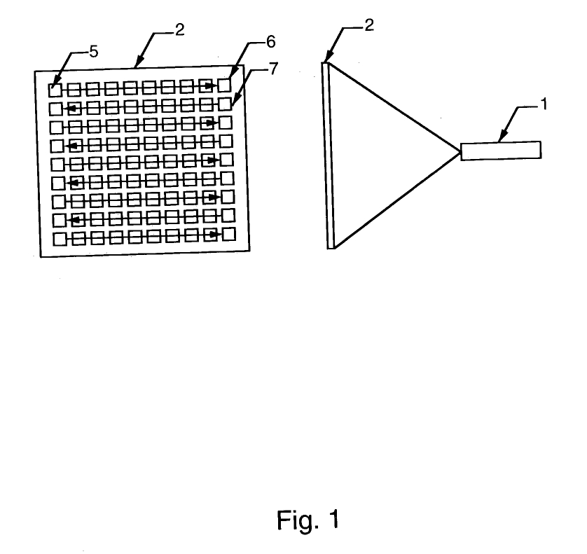

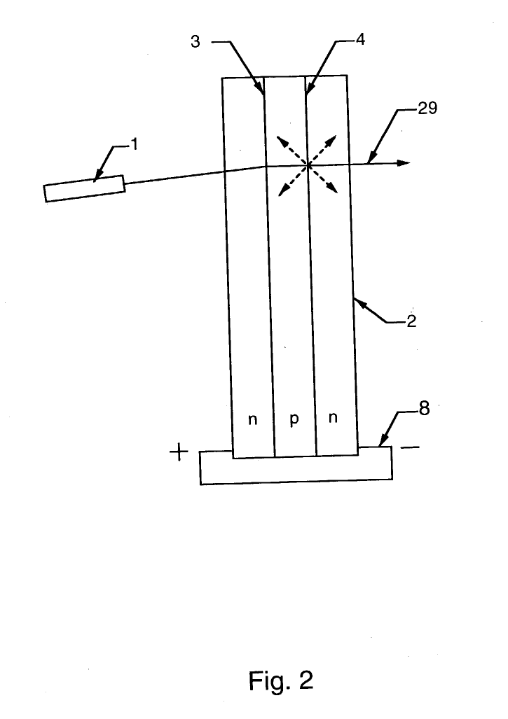

The principal embodiment of the invention aims to provide a large screen display system utilizing a scanning laser. The heart of the invention relies on a scanning laser 1 that scans onto a two-dimensional display screen panel 2, with reference to FIG. 1. By example, the laser 1 scans from left to right across the display screen 2, starting with the top row of picture elements or pixels, then scans from right to left across the row of pixels directly beneath until the entire display screen is scanned, whereby the pixels are laid out in a matrix array. Thus, the scanning laser would start with pixel 5 at the left end of the top row of pixels, scanning across to pixel 6 at the right end of the top row of pixels. The laser would then advance to the next row below pixel 6 starting with pixel 7 at the right end directly below pixel 6, and scans to the left end again advancing to the next row of pixels below, repeating this cycle until the entire screen 2 is scanned. A cross sectional view of the display screen 2, as illustrated in FIG. 2, shows a monolithic composition of the display screen comprising three layers in a traditional phototransistor construction. Hence, there are typically n-p-n layers or panels sandwiched together whereby the scanning laser 1 hits one region 3, and light is emitted from another region 4, located directly behind region 3 where the incident light is present. In a further embodiment, the light that is emitted is brighter than the incident light, thus there is amplification of light occurring in the phototransistor. In the preferred embodiment, the incident light by the laser 1 is in the infrared spectrum making it invisible to the naked eye, and the light emitted is in the blue color spectrum. The entire display panel is comprised of the described monolithic composition. Essentially, wherever the laser strikes the display screen panel, light 29 is emitted at that exact location directly behind the location of incident light. In a further embodiment, the incident infrared light and emitted light enter and leave the display panel from the same side. Thus, the laser and the observer may be on the same side of the display screen or opposite sides (previous embodiment). There is an electric field 8 present across the phototransistor or display screen, which biases the transistor, thus providing a voltage across the transistor circuit. This complete transistor circuit allows a charge to flow in one direction. In the preferred embodiment, one of the regions is a photosensitive region and is photosensitive only to a small range of light in the infrared spectrum, or around this spectrum. Thus, the emitted light in the blue spectrum does not create interference at the photosensitive layer. Basically, the infrared light from the laser strikes a photosensitive region or layer 3 in the display screen that is sensitive to the infrared light, thereby reducing a barrier for carriers to flow through causing recombination in another area of the phototransistor circuit, resulting in light being emitted at area 4. Due to the presence of the transistor circuit there is amplification, hence there is a conversion of light to carriers generated in the photosensitive layer at 3 and recombination at area 4 where there is light output. Thus, the incident infrared laser light that strikes a photosensitive region of the display reduces a barrier for charged carriers to travel and recombine in another area of the phototransistor circuit, in the presence of an applied electric field, causing light to be emitted.

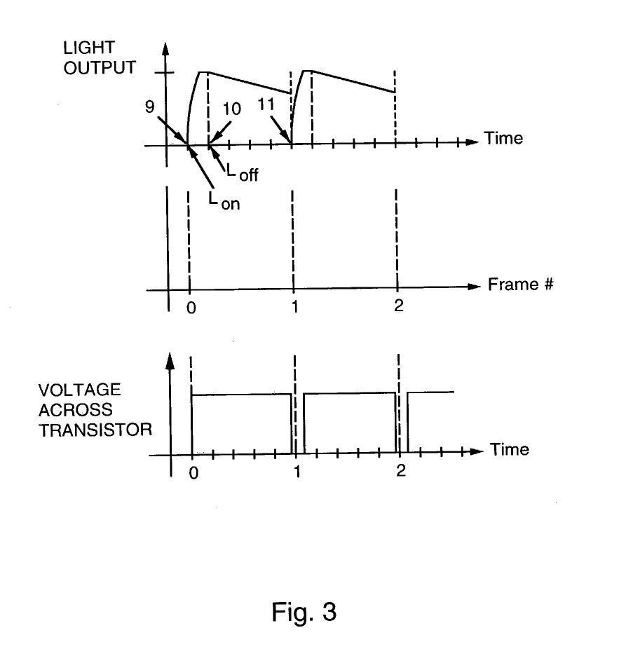

With further reference to FIG. 2, when the infrared laser beam strikes the photosensitive region 3, holes and electron pairs (or carriers) are created, and when those holes and electron pairs are created, they cause a current to flow causing light emission to occur, but there is a mechanism that makes the current persist for a longer period of time. In particular, the effect of those holes and electron pairs is that they reduce the barrier but they persist for a period of time, so that basically, the light output comes on very quickly as holes and electron pairs are created, but the light output is very slow in degradation. Persistence is due to the fact that once the barrier is reduced, it takes a certain amount of time to come back up. The resulting effect of the infrared laser beam striking the photosensitive region is that barrier is reduced for a large period of time, which is equal to or may be larger than the frame period. Referring now to FIG. 3, the frame period is the duration of each frame, whereby multiple frames per second provides a video display of fluent motion. For example TV has 30 to 60 frames per second. Each frame typically displays a new image with some difference to the previous frame, and the period that the laser is on is very short compared to the frame period, for each pixel it addresses on the display screen. Thus, for one pixel on the display, the laser is turned on at 9 (Lₒₙ) and off at 10 (L_{off}) and the pixel continues to glow until the end of the frame at 11. Hence the frame period is defined as the duration from 9 to 11. It is necessary for the laser to scan each pixel only for a very short period of time, so that it may address all or most pixels in the display in sequence within one frame period, then start over again for the next frame period. At the end of the frame period 11, the voltage is turned off to get the light output to be completely shut off for all pixels so that persistence does not occur into the next frame period, since different pixels may or may not require light output for different frames. The voltage is shut off and turned on moments after, to start the next frame. This is further demonstrated in FIG. 3, where the voltage across the transistor is shown to be shut off towards the end of each frame, and turned on again at the start of the next frame. Therefore, at the start of each frame period the light output should be at zero or very small for each pixel on the display screen. In the preferred embodiment, the transistor circuit is designed to provide persistence about the same time frame of each frame period, as this will reduce the need to turn off the voltage at the end of each frame. Thus, the amount of persistence is related to or is a function of the frame period in this particular embodiment.

In another embodiment of the invention, the amount of persistence provided is designed to be much longer than the frame period, and the voltage is turned off at the end of the frame period. This effectively terminates all light output instantaneously for all pixels on the display screen, for each frame period. In a further embodiment, the voltage 8 applied to the transistor circuit is reverse polarized at the end of each frame period, to get rid of all the charged carriers that are persisting there, thereby terminating all light output instantaneously for all pixels on the display screen, at the end of each frame period.

In a further embodiment, the voltage 8 applied to the transistor circuit is cycled at the end of each frame period into a forward, reverse, forward, reverse polarization to get rid of all the charged carriers that are persisting there, thereby terminating all light output instantaneously for all pixels on the display screen, at the end of each frame period.

In a further embodiment, the persistence may be caused by various effects including persistence of carriers, persistence due to a capacitance effect and also caused by light feedback. Thus, with reference to FIG. 11, the display screen 2 is comprised of a photoconductor 30 in contact with a photo emitter 31, with a panel 32 of a matrix array of red, green, and blue phosphor pixels against the photo emitter. As light from the laser 1 strikes a pixel on the photoconductor 30 and carriers are generated resulting in the emission of light at the photo emitter 31, light hits the color phosphor pixels, which is reemitted in the various colors. This results in a light output of a particular color for that pixel for the observer 34 to see. However, some of this light emitted at the photo emitter is directed back toward the photoconductor, and this results in a feedback loop generating more carriers, persistence, and more light output. Therefore, the photoconductor in this embodiment reacts to the color of emitted light by the photo emitter unlike the preferred embodiment, in which the photoconductor is sensitive only to infrared light. With the panel of phosphors against the photo emitter as shown in FIG. 11, external light will not be able to enter to add to the persistence effect. An infrared panel 33 is also required in front of the photoconductor to prevent light other than the laser's wavelength entering the display screen and creating carriers, leading to erroneous light output.

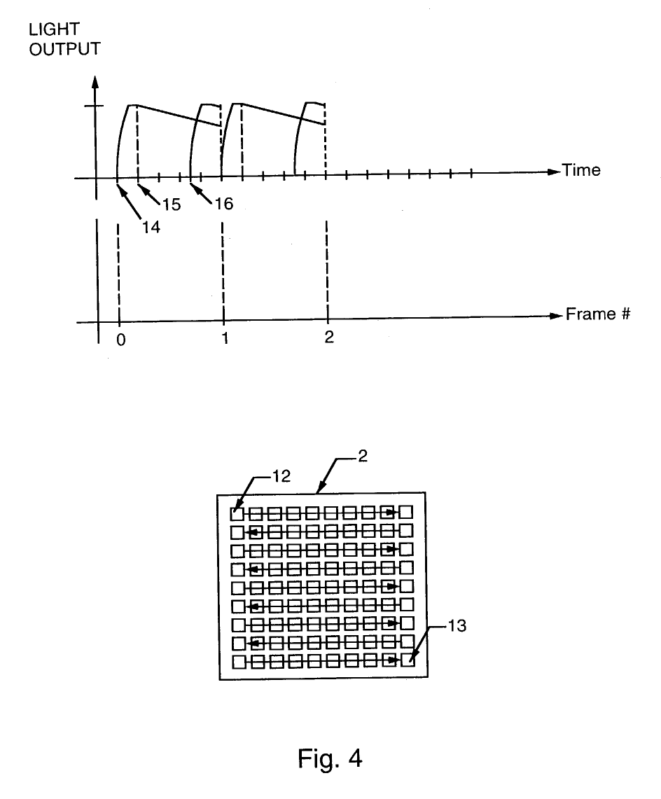

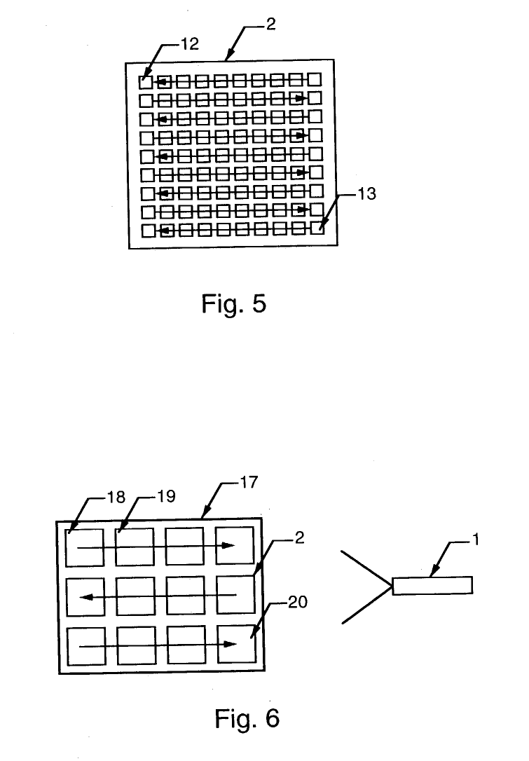

In accordance with the present invention, with reference to FIG. 4, the laser scans the display screen 2 starting with pixel 12 at the top left of the screen, and sweeps across row by row until it reaches the last pixel 13 on the screen, whereby all persistence is cut off at point 16 to start the next frame. Since there is a lag in time from the point 14 at which the laser first strikes pixel 12 and the point 15 at which the laser first strikes pixel 13, then pixel 12 remains on much longer than pixel 13 which is not the ideal situation, as all pixels should remain on for an equal amount of time for as much time as possible in each frame. To provide a solution, the laser would scan in a forward direction as described in FIG. 4 and then scan the display screen 2 in a reverse direction, as illustrated in FIG. 5. This pattern of scanning in a forward direction then followed by scanning in a reverse direction is cycled continuously. Thus, pixel 13 which had very little on time as it was scanned last in the forward scanning direction as FIG. 4 would have a much longer on time in the reverse scanning direction of FIG. 5, as it is now scanned first. Therefore, on average over one forward and reverse scanning cycle, each pixel on the display screen 2 would have an equal amount of on time.

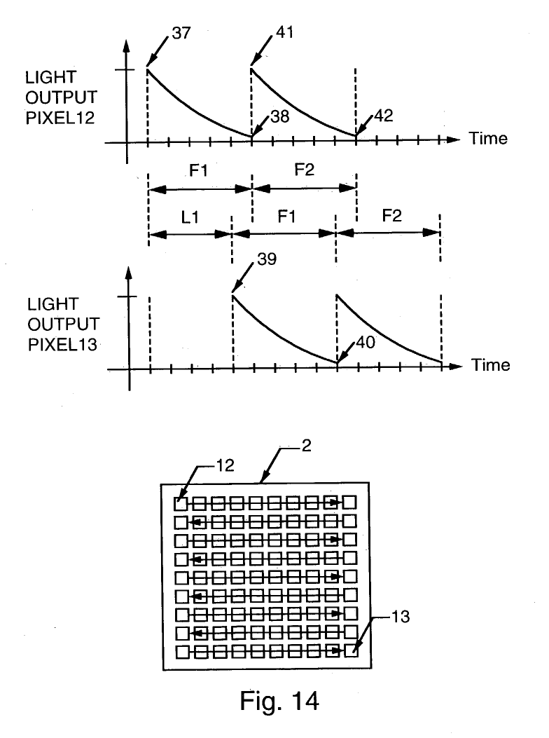

In the preferred embodiment, the persistence is approximately the size of one frame period and it is not necessary to turn off the voltage and or have forward and reverse scanning over two consecutive frames, as the amount of time each pixel is on will be roughly the same amount at maximum brightness. Thus, the amount of time each scanned pixel remains on is approximately one frame period, and the persistence also lasts approximately one frame period. For pixels intended to emit light at maximum brightness, after being scanned by the laser, light is emitted for one frame period only for these scanned pixels. Therefore, if the first pixel and last pixel on the display screen need to be at maximum brightness for particular frame periods, then with further reference to FIG. 14, the laser would strike the first pixel 12 on the display screen 2 and move over to the last pixel 13. The pixel 12 would emit light at maximum intensity 37, which degrades to 38 at the end of that picture frame. Since there is a lag in time between the laser striking the first and last pixel on the display screen, after striking the first pixel 12 and then moving to the last pixel 13, there is also the same lag in time when these two pixels emit light. Pixel 13 would emit light at 39, which degrades to 40 at the end of the picture frame. Thus, after striking pixel 13 the laser may move over to strike the first pixel 12 again for the next frame period at 41, but pixel 13 continues to emit light even after the laser strikes pixel 12 again which begins to emit light for the next frame period ending at 42. Pixel 13 will continue to emit light until it degrades to 40 at the end of the frame period. Hence, with further reference to FIG. 14, the frame period for the first frame is represented by F1, and the frame period for the second frame represented by F2, etc. The lag or difference in time from the laser striking pixel 12 and pixel 13 is represented by L1. Therefore, from the instant the laser strikes pixel 12 for the first frame, the time taken for pixel 13 to stop emitting light for the first frame is represented by L1+F1, and during this time pixel 12 has completed emitting light for all of frame F1 and most of frame F2. The first frame F1 for pixel 13 starts at a time L1 after the start of the first frame for pixel 12, which is the time taken for the laser to traverse from pixel 12 to pixel 13.

In a further explanation of this embodiment, it is necessary to explain that as the laser scans, it is focused on each pixel for a different amount of time, which causes a different amount of light to be incident on each pixel in aggregate, so that different pixels may have different emission intensities to produce a gray scale effect for the various colors.

In another embodiment, the laser scans the entire display screen very fast, thus by example, if the frame period is 30 milliseconds, the laser will scan the entire display screen in 30 microseconds and repeat scanning an approximate total of 1000 times in each frame period. Therefore, for a particular pixel that must remain on at maximum intensity for one frame period, the laser will scan this pixel on the first pass of that frame period generating a light output and persistence, then again at approximately the 500^{th} pass when the pixel output intensity is about half, thereby increasing the output intensity to maximum once again slowly degrading until terminated at the end of the frame period. This is effectively a means of producing a gray scale display. Thus, if a particular pixel must be at 50% intensity, then by example, the laser would scan that pixel at the 500^{th} pass (at half the frame period) only for instances where the persistence lasts for approximately one entire frame period. The laser would not scan this pixel before or again after the scan at the 500^{th} pass. At the end of each frame period the voltage may be shut off or cycled to terminate light output for all pixels, as previously explained. This means that this pixel would only emit light for half the frame period, as it would not have started emitting light until being scanned at the 500^{th} pass. In another example where the material of the display screen is designed to produce a persistence which may be much shorter than a frame period (one thousandth of a frame period for example), then for any pixel that must be at 50% intensity, the laser would scan that pixel at the 500^{th} pass (at half the frame period) and repeatedly every one thousandth of a frame period, to sustain the maximum output intensity until the end of each frame period. Hence, by this example, the laser would have a scan period of one thousandth of a frame period, whereby a scan period is the time it takes the laser to completely scan all pixels on the entire display screen. Thus, the laser scans this pixel to emit light at 50% intensity on the 500^{th} pass, 501^{st} pass, 502^{nd} pass, and every other pass until the end of the frame period. This can be used to produce any desired gray scale effect on the display screen.

In a further embodiment, the display screen is made of certain transistor materials and produces persistence of a specific duration, which may be significantly less than a frame period. If the persistence is much longer than the frame period, and allowed to extend into the next frame period, then the display would be hazy. To the contrary, if the persistence is shorter than the frame period, and the pixels scanned only once for the frame period, then the display would not appear bright enough. Although the ideal condition is to have the persistence last for the same duration as a frame period, there may be such instances where the persistence is very short compared to the frame period. Thus, the laser's scan rate can be tuned to match the duration of persistence. Therefore by example, if a video display needs to have a frame period of 1/30 of a second, and the persistence only lasts 1/3000 of a second (which is 100 times less), then the laser's scan period to completely scan all pixels on the display screen can be tuned to match this persistence duration. Hence, to keep a pixel illuminated for an entire frame period, the laser would scan that pixel at least 100 times in the frame period towards the end of the persistence duration. This method is particularly useful in display screens of short persistence characteristics, or alternately in producing gray scale displays. In a further embodiment, the laser's scan rate may be much shorter than this persistence duration. Therefore, the laser may scan any pixel at the end of the persistence duration (as previously explained) or many times during the persistence duration, to keep the pixel illuminated.

In another embodiment of the invention, with reference to FIG. 6, a very large display screen 17 is made comprising a matrix array of multiple display screen panels 2 as previously described. The laser 1 would start scanning the top left display screen panel 18 then after completely scanning that display screen panel, move across to the next display panel 19 in the matrix array, scanning each display panel in every row, scanning each row in sequence until it reaches the last display panel 20, at the bottom right corner of the large display panel 17. Instead of terminating the persistence at the end of each frame period as previously described for all display panels at once, the voltage is turned off for each individual display panel immediately before the laser starts scanning pixels on it for the next frame period. This allows all other pixels to glow until just before the laser scans the display panel on which they are located, to create the next frame display. This is necessary as there would be a significant lag in time between the first and last display panel on the large display screen 17, and this embodiment allows all other pixels to glow except those on the display panel being scanned by the laser.

In another embodiment of the invention, the laser is modulated to be dimmer or brighter on each pixel and the amount of time the laser is directed on each pixel varied. Since the light output of each pixel is directly proportional to the intensity and duration of the laser on each pixel, altering the intensity and or duration of the laser on each pixel may produce any desired gray-scale output.

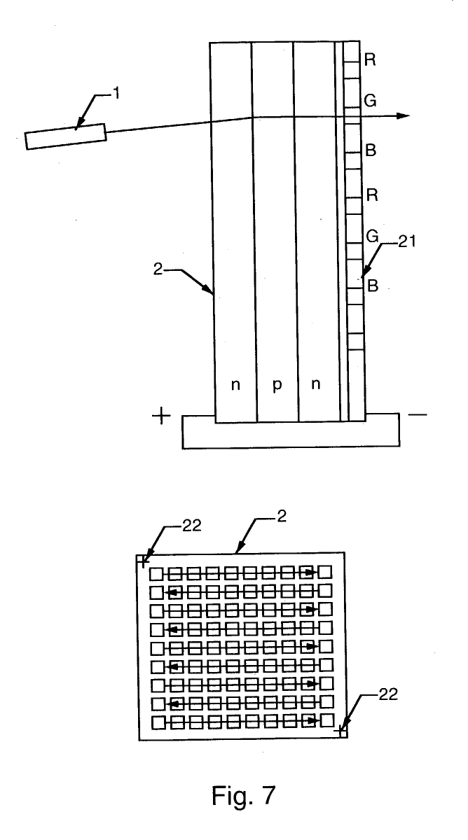

In the preferred embodiment of the invention, the light output is blue at each pixel on the display screen. To produce a color display screen, with reference to FIG. 7, a phosphor-coated panel 21 is applied against the display panel 2 comprising Red (R), Green (G), and Blue (B) groups or patterns (RGB) as found in color television screen. Thus, the RGB phosphor patterns are located directly in line with pixels that provide blue light output, and the laser knows exactly where the Red, Green and Blue phosphors are located to be able to address these locations accurately, of varied intensity and or duration, to provide a true color display. The phosphor-coated panel essentially converts the blue emitted light into Red, Green, and Blue colors at respective locations. There are alignment markers 22 at the corners of the display screen 2 to aid the laser in precisely targeting the Red, Green and Blue phosphors on each display screen. For every frame or at frequent intervals, the laser would check the alignment with these markers and make necessary corrections to its targeting accordingly, to provide maximum efficiency and optimum display quality of the device.

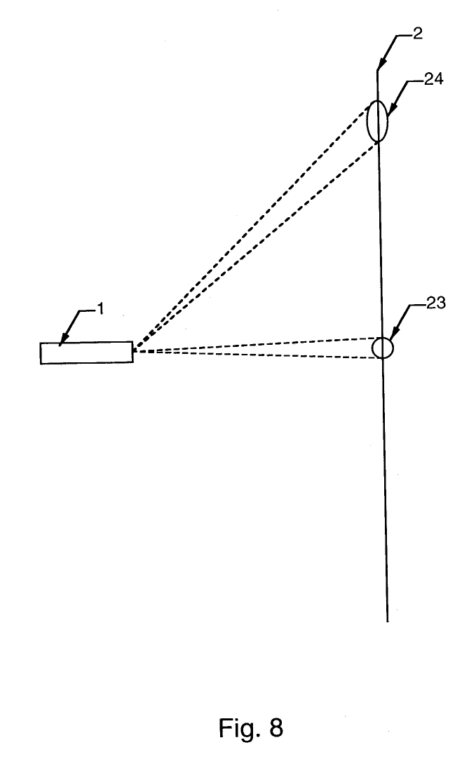

The size and shape of the Red (R), Green (G), and Blue (B) groups or patterns are designed to match the corresponding size and shape of the laser's beam. In a preferred embodiment, the laser's beam is of a square shape corresponding in size and shape to the Red (R), Green (G), and Blue (B) groups or patterns on the display panel, for maximum efficiency of the display device. In another embodiment, with reference to FIG. 8, the shape of the laser's footprint on the display screen 2 changes due to the angle of incidence of the laser's beam. Thus, if the laser 1 has a circular beam, then at location 23 on the display screen 2 the laser would have a circular footprint at a zero angle of incidence, but at location 24 on the display, the laser would have an elliptical footprint as the angle of incidence increases with respect to the display screen. The optics of the laser is designed to compensate for this elongation in dot size as the angle of incidence increases, thereby producing a consistent dot size and shape across the display screen, in one embodiment of the invention. The optics of the laser is designed to compensate for any decrease in intensity at the screen 2 by boosting the laser's intensity where required, as the laser beam's intensity may decrease as the angle of incidence increases. By example, location 23 at zero angle of incidence may have a higher intensity of incident light provided by the laser compared to location 24 which is at a higher angle of incidence. Therefore the optics of the laser would boost the laser's intensity at location 24 to match the intensity at location 23.

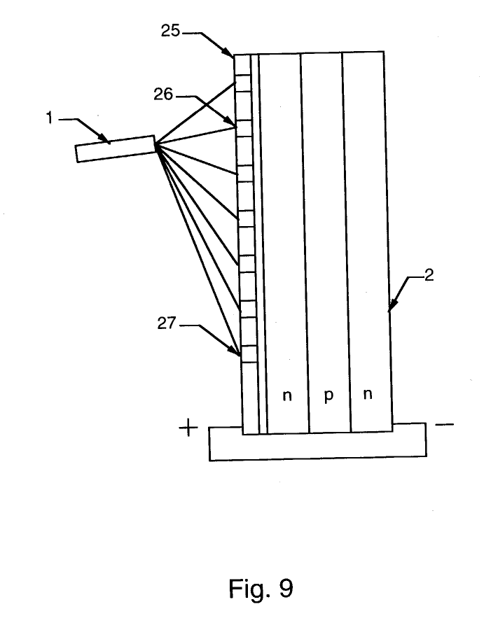

In another embodiment of the invention, with reference to FIG. 9, a grid 25 is placed between the laser 1 and the screen 2, against the screen to provide an equal laser beam size or footprint on each pixel of the display screen. The optics of the laser is designed to compensate for any decrease in intensity at the screen 2 by boosting the laser's intensity where IS required, as the laser beam's intensity may decrease as the angle of incidence increases. In particular, the laser beam intensity on the display screen 2 at location 26 may be greater than at location 27, whereby location 26 is at a lesser angle in incidence than 27. Thus, the laser's optics would boost the laser beam's intensity at location 27 to compensate for any variation with respect to location 26.

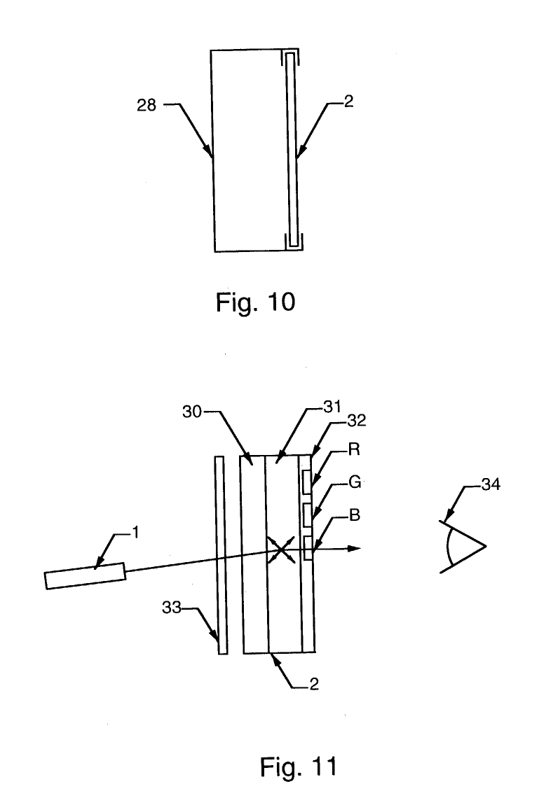

The display screen as described in all embodiments of the invention is designed to be removable from its location within a housing, as the materials used in the screen's monolithic composition have a limited lifespan. Therefore the user may need to replace the screen after a few thousand hours of use, and easy removal and insertion of a new display screen is practical. With reference to FIG. 10, this embodiment of the invention draws reference to a housing 28, which contains the display screen 2, which can be easily removed and replaced by another display screen of similar size.

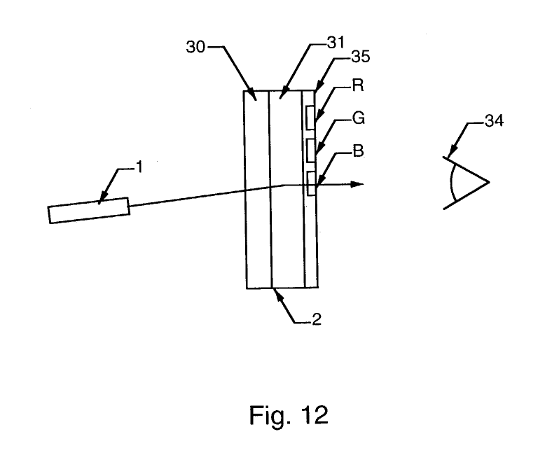

In accordance with another embodiment of the invention, and with reference to FIG. 12, the display screen 2 is comprised of a photoconductor 30 against a photo emitter 31, which is in contact with a panel of filters 35. The filters are the size and shape of pixels and arranged in a matrix array of red, green, and blue filters, to provide a RGB color display panel. Therefore, infrared light from the laser 1 is directed at a pixel in the display screen 2, passing to the photoconductor generating carriers and light output at the photo emitter 31, which passes through a color filter in panel 35, producing a color output for that pixel on the display screen, as seen by the observer 34. The light output at the photo emitter 31 for this particular embodiment, may be of a broad color spectrum or white in certain instances, with the color filters designed to produce red, green, and blue colors (to the observer 34) depending on the spectrum of light produced by the photo emitter.

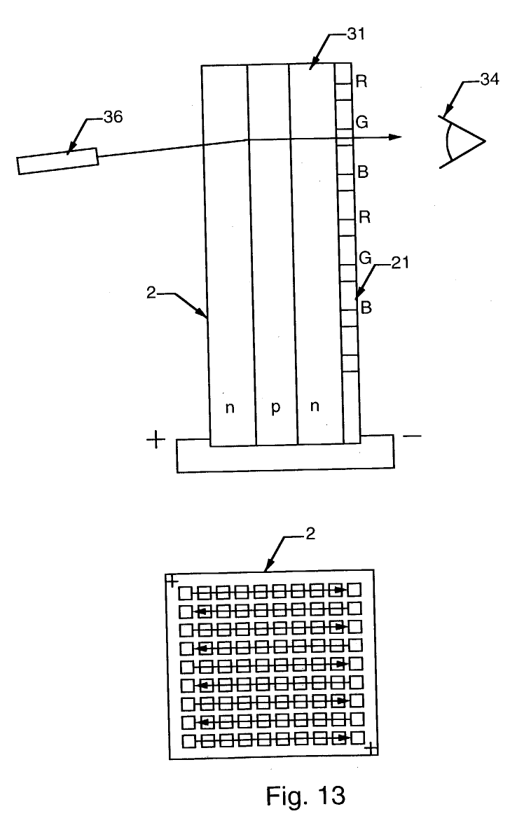

In a further embodiment of the invention, and with reference to FIG. 13, an infrared projector 36 replaces the infrared laser beam as previously described in earlier embodiments. One advantage of implementing an infrared projector is that all pixels are scanned simultaneously on the display screen 2, and there is no difference in scan time between any two pixels on the display screen. The infrared projector may be on the same side of the display screen as the observer, or on opposite sides as shown in FIG. 13. Another important advantage is that the persistence may be of a very short duration or none at all, and the infrared projector continuously scans pixels that need addressing to sustain a continuous light output, or to produce any desired gray scale effect. Hence, the infrared projector will address all appropriate pixels with infrared light, and the blue light output from the photo emitter 31 would be reemitted in all the various colors to the observer 34, after passing through the phosphor-coated panel 21 applied against the photo emitter, comprising Red (R), Green (G), and Blue (B) groups or patterns (RGB) of pixels, as found in color television screens.

In another embodiment of the invention, and with reference to FIG. 13, the photo emitter 31 would have colors already patterned on it, thus any resultant light output would be in Red, Green or Blue colors, for each pixel scanned with infrared light. This presents another method of producing a color display screen in accordance with the present invention.

What is claimed:

1. A display device comprising a phototransistor that shows picture frames containing an array of picture elements, each scanned by a laser beam for each picture frame displayed, such that the laser beam incident on each picture element of the display is converted and emitted as light in another spectrum, in the presence of an applied to electric field.

2. A display device as claimed in claim 1 such that the laser beam is in the infrared spectrum.

3. A display device as claimed in claim 1 such that the emitted light is in the blue color spectrum.

4. A display device as claimed in claim 1 such that as the incident laser beam strikes the display, a mechanism makes a current persist for a period of time to keep light emitted for this period.

5. A display device as claimed in claim 1 such that removing the electric field terminates all emitted light.

6. A display device as claimed in claim 1 such that reversing the electric field terminates all emitted light.

7. A display device as claimed in claim 1 such that cycling the electric field into a forward and a reverse cycle any number of times terminates all emitted light.

8. A display device as claimed in claim 1 such that a panel containing color phosphor picture elements is positioned against the display, thereby reemitting light in colors.

9. A display device as claimed in claim 1 such that the laser beam scans each picture element on the display in a forward path followed by a reverse path, to equalize the amount of time each pixel emits light at maximum brightness.

10. A display device as claimed in claim 1 such that the laser beam is incident on each picture element in aggregate for a different duration for each picture frame, whereby the emitted light by each picture element is proportional to the duration of incident light.

11. A display device as claimed in claim 1 such that the laser beam scans each picture element on the display a different number of times within each picture frame, whereby the emitted light by each picture element is proportional to the cumulative duration of incident light.

12. A display device comprising multiple display screens as claimed in claim 1, scanned by the same laser beam in sequence for each picture frame.

13. A display device as claimed in claim 1 such that the array of picture elements is contained within a housing and said array of picture elements is removable and replaceable.

14. A display device as claimed in claim 1 such that the laser beam is incident on each picture element for a different intensity for each picture frame, whereby the emitted light by each picture element is proportional to the intensity and or duration of incident light.

15. A display device as claimed in claim 1 such that the laser beam is adjusted to provide a consistent size and shape at all picture elements.

16. A display device as claimed in claim 1 such that the laser beam is adjusted to provide a consistent intensity at all picture elements.

17. A display device as claimed in claim 1 such that the emitted light may be of any color and a panel containing color filter picture elements is positioned against the display, thereby reemitting light in colors.

18. A display device as claimed in claim 1 such that the incident light is produced by an infrared projector, which simultaneously scans all picture elements on the display, for each picture frame.
